(19) United States
(12) Patent Application Publication
(10) Pub. No.: US 2007/0186221 A1
(43) Pub. Date: Aug. 9, 2007

(54) Optical disc apparatus

(75) Inventors: Sojiro Kirihara, Kawasaki (JP); Yoshiyuki Tanaka, Kawasaki (JP); Shinya Tsubota, Mito (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/516,108

(22) Filed: Sep. 5, 2006

(30) Foreign Application Priority Data
Feb. 8, 2006 (JP) 2006-031038

(51) Int. Cl. G11B 17/04

(52) U.S. Cl. 720/620

(57) ABSTRACT

An optical disc apparatus is configured so that a cover member covering a second base, which is displaceable relative to a first base as an apparatus base and makes up a support portion of a unit mechanism section, covers plane areas located on both sides of an optical pickup move area of the unit mechanism section of the second base plane areas, and during loading or unloading of an optical disc, supports a rotated and displaced eject arm member by a plane part covering the plane area on the side of the eject arm member, of the both plane areas. The eject arm member is made to be located outside an orthogonal projection area of the optical disc upon completion of the loading.

### CLAIM OF PRIORITY

The present application claims priority from Japanese application serial No. P2006-31038, filed on Feb. 8, 2006, the content of which is hereby incorporated by reference into this application.

### BACKGROUND OF THE INVENTION

1. Technical Field of the Invention

The present invention relates to an optical disc apparatus, and particularly to a support technology of an eject arm member for loading and unloading an optical disc.

2. Description of the Related Art

Technologies related to the present invention are described, for example, in Japanese Patent Publication Laid-Open Nos. 2002-352498 and 2005-243091. In JP-A-2002-352498, there is described a disc apparatus including an eject lever 100 (eject arm) having a guide 101 the outer periphery of a disc abuts at a movable side end portion to rotate and displace the movable side end portion around a rotation support point 102 in association with disc insertion/ejection operations. Described in JP-A-2005-243091 is a configuration, in a disc apparatus of slot-in type dedicated to 12 cm disc, that includes a disc support arm 17 having a stopper 19 the front rim of an 8 cm disc abuts at an end in order to block penetration of the 8 cm disc.

### SUMMARY OF THE INVENTION

Of the conventional technologies described in the above publications, the eject lever 100 described in JP-A-2002-352498 is configured, for example, as shown in FIGS. 9, 10 and 11, so that a wide width configuration is used and a large part of the plane of the lever is located within the outer periphery of the disc also in the state where the disc loading is completed. Because the eject lever 100 is thought to be supported only by the rotation support point 102, when the disc is loaded, the disc surface is likely to come into contact with a spindle motor 31 and the like to cause a stain or damage on the recording surface, unless the disc support position by the eject lever 100 is set sufficiently higher than the end portions of the spindle motor 31 and the like. Raising the disc support position in the eject lever 100 leads to an increase of the thickness of the disc apparatus, which blocks the apparatus from being made thinner. In addition, the plane of the eject lever 100 overlaps the disc surface also in the state where the disc loading is completed. Because of this configuration, it is necessary to raise the height position of the eject lever 100 to sufficiently increase the distance between a traverse 30 and the eject lever 100, in order to prevent the eject lever 100 from being pushed by the parts on the side of the traverse 30 and displaced to the disc surface side, even in the case where the traverse 30 is raised in the disc surface direction for chucking the disc. It is further necessary to raise the height position of the disc surface to sufficiently increase the distance between the eject lever 100 and the disc surface, in order to prevent the disc surface from coming into contact with the eject lever 100 during disc rotation. Raising the height position of the eject lever 100 and raising the height position of the disc surface lead to a substantial increase of the thickness of the disc apparatus, which blocks the apparatus from being made thinner.

As a technology for restricting the height position of the wide-width eject lever 100 as described above, for example, it is conceivable that height restriction means such as a guide shaft member is provided on the side of a base body 10 or rear base 13 and a wide-width plane part of the eject lever 100 is supported by the means to restrict the height during disc loading or upon completion of loading (including when the play operation is available). However, reduction in the thickness of the apparatus may be difficult due to the above reasons, as long as the plane of the eject lever 100 is configured to overlap the disc surface in the loading completion state.

Further, in the technology described in JP-A-2005-243091, it is disclosed a disc support arm 17 with a narrow width configuration, which swings around a support point by being pushed by a 12 cm disc when loaded, and locates outside the outer periphery of the disc in the state where the disc loading is completed (FIGS. 2, 7A and 7B). The disc support arm 17 is entirely supported by the swing support point. Because of this configuration, the disc surface may come into contact with a cramp head 7 and a turntable 10 to cause a stain or damage during disc loading, unless the disc support position in the disc support arm 17 is set sufficiently higher than the cramp head 7 and turntable 10. Raising the disc support position in the disc support arm 17 also leads to an increase of the thickness of the disc apparatus, which blocks the apparatus from being made thinner.

In light of the circumstances of the conventional technologies, it is desirable in an optical disc apparatus to make the apparatus much thinner by lowering the height position of a disc surface, in the state where the disc surface is protected during the loading and unloading of the optical disc.

An object of the present invention is to solve such a problem and provide a reliable optical disc apparatus having a thin configuration.

The present invention is a technology that can solve the above problem and achieve the above object.

More specifically, in the invention, an optical disc apparatus is configured so that a cover member covering a second base, which is displaceable relative to a first base as an apparatus base and makes up a support portion of a unit mechanism section, covers plane areas located on both sides of an optical pickup move area in the unit mechanism section of the second base plane areas, and during the loading or unloading of an optical disc, supports a rotated and displaced eject arm member by a plane part covering the plane area on the side of the eject arm member, of the both plane areas. Further, the eject arm member is configured to be located outside an orthogonal projection area of the optical disc upon completion of loading (including when the play operation is available).

### BRIEF DESCRIPTION OF THE DRAWINGS

FIG. 1 is a view showing an example of the general configuration of an optical disc apparatus as an embodiment of the present invention;

FIG. 2 is a view showing the state where a play operation is available in the optical disc apparatus of FIG. 1;

FIG. 3 is an illustrative view of an eject arm member and its support configuration in the optical disc apparatus of FIGS. 1 and 2;

FIG. 4 is a configuration view of a cover member in the optical disc apparatus of FIGS. 1 and 2;

FIG. 5 is a diagram showing an example of the displacement characteristic of the eject arm member in the optical disc apparatus of FIGS. 1 and 2;

FIGS. 6A and 6B are illustrative views of a thickness reduction effect in the optical disc apparatus of FIGS. 1 and 2; and

FIGS. 7A and 7B are illustrative views of another thickness reduction effect in the optical disc apparatus of FIGS. 1 and 2.

### DETAILED DESCRIPTION OF THE PREFERRED EMBODIMENT

Hereinafter, an embodiment of the present invention will be described with reference to the accompanying drawings.

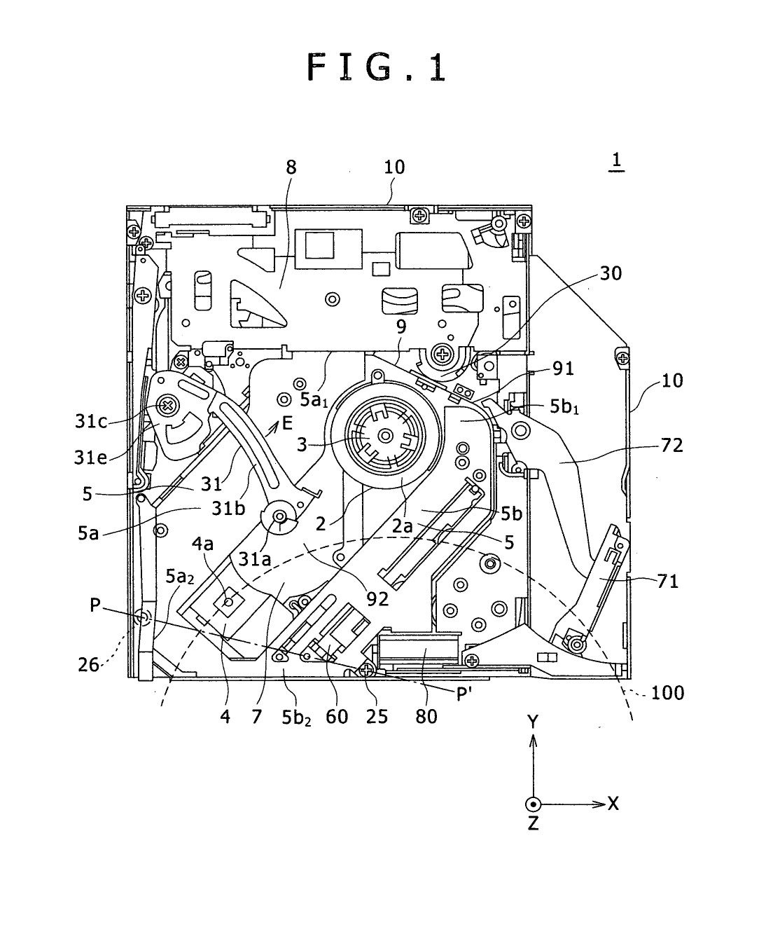

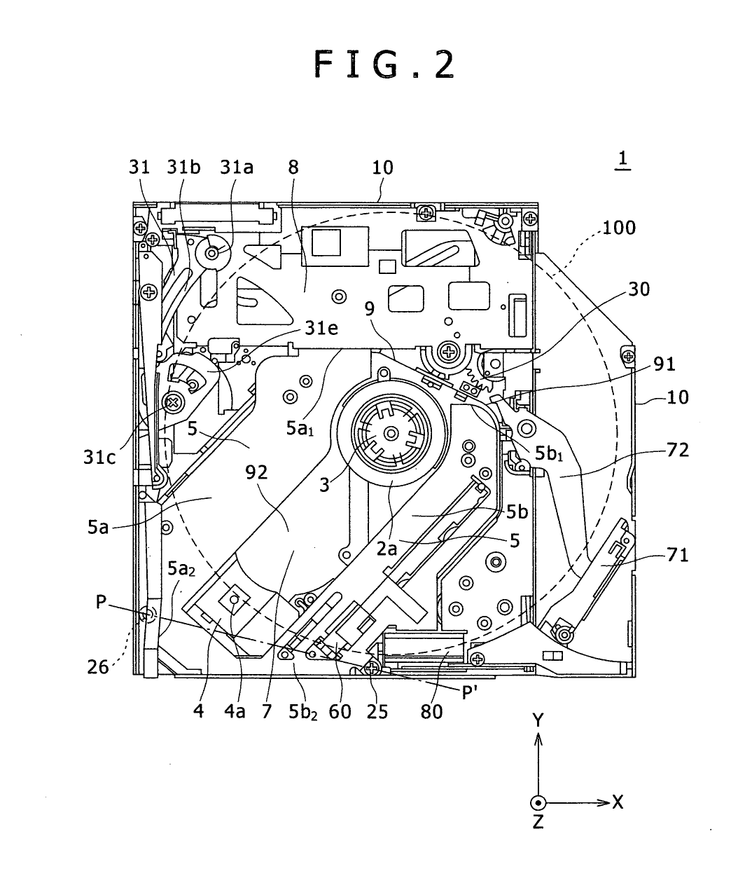

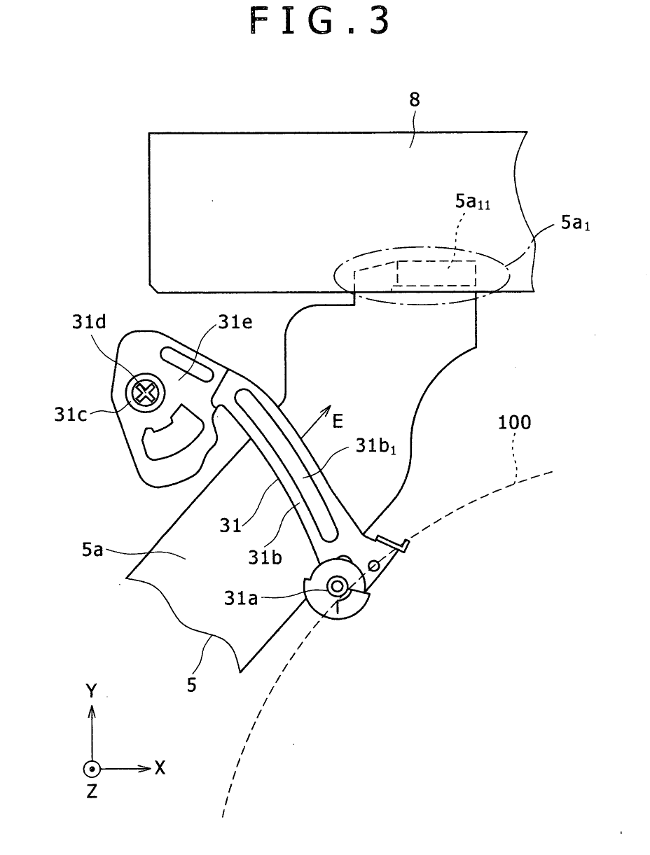

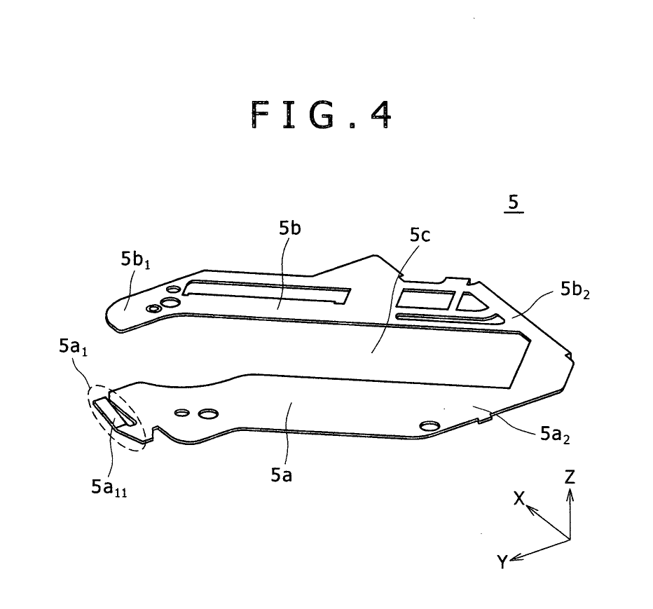

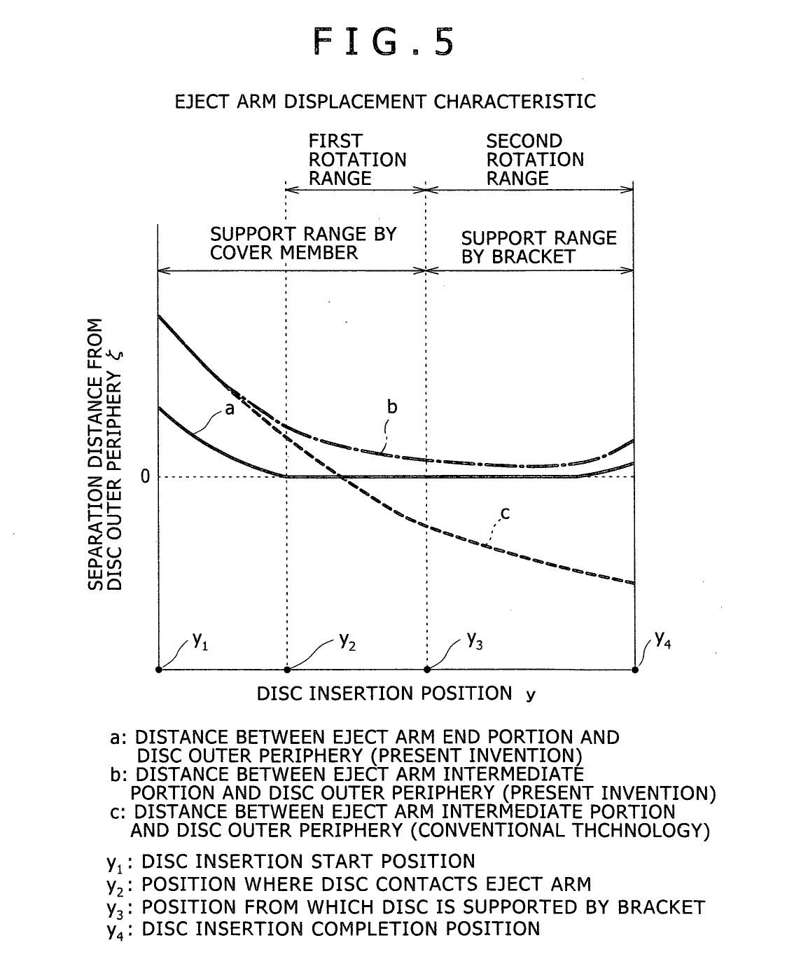

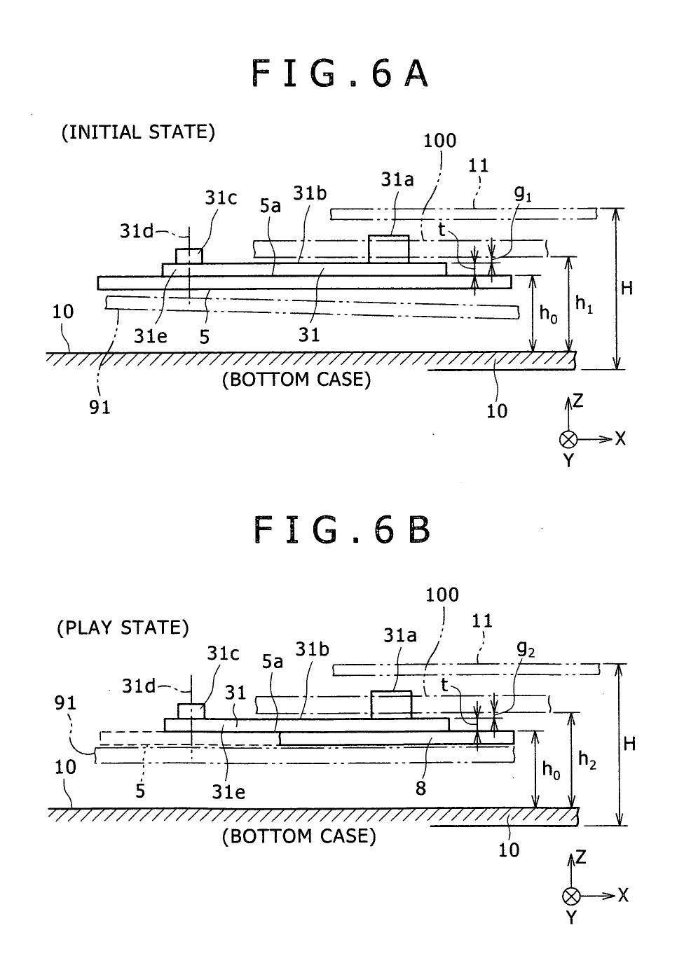

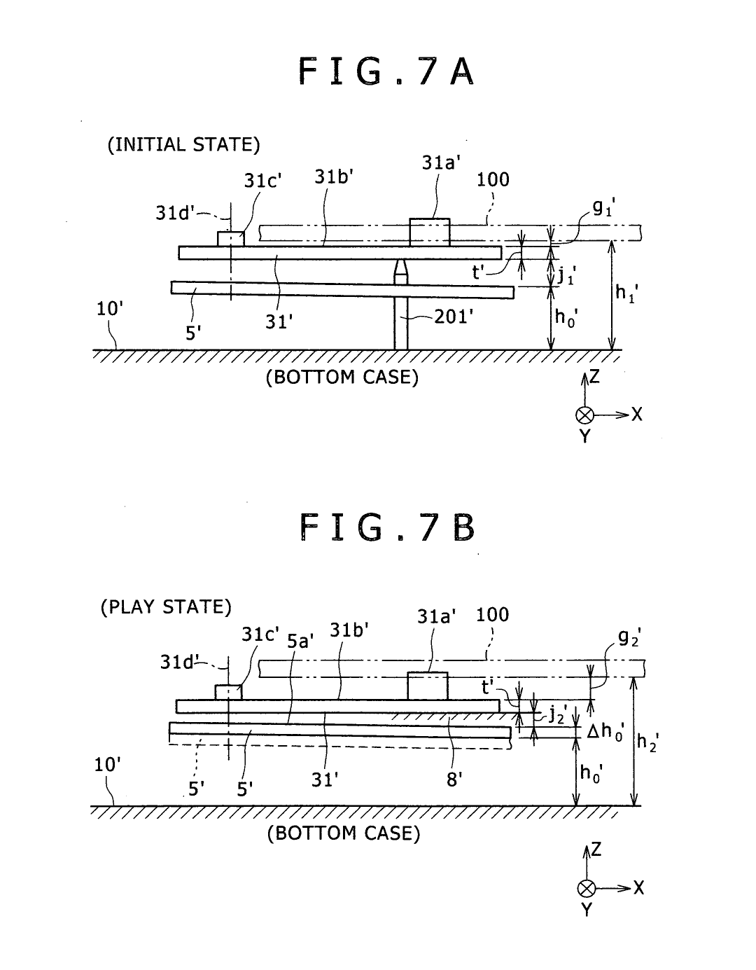

FIGS. 1 to 7A and 7B are illustrative views of an embodiment of the invention. FIG. 1 is a view showing an example of the general configuration of an optical disc apparatus of slot-in type as an embodiment of the invention, which shows the initial state before an optical disc is loaded. FIG. 2 is a view showing the state where the play operation is available (including a play state) after the optical disc has been loaded in the optical disc apparatus of FIG. 1. FIG. 3 is an illustrative view of an eject arm member and its support configuration in the optical disc apparatus of FIGS. 1 and 2. FIG. 4 is a configuration view of a cover member in the optical disc apparatus of FIGS. 1 and 2. FIG. 5 is a diagram showing an example of the displacement characteristic of the eject arm member in the optical disc apparatus of FIGS. 1 and 2. FIGS. 6A, 6B, 7A and 7B are illustrative views of the thickness reduction effect in the optical disc apparatus of FIGS. 1 and 2. In the drawings, the same reference numerals and symbols are given to the same components and the same coordinate axes are used.

FIGS. 1 and 2 are views each showing an example of the configuration of the front side (the side the disc is placed on) of the optical disc apparatus as the embodiment of the invention.

In FIGS. 1 and 2, reference numeral 1 denotes an optical disc apparatus; 100 denotes an optical disc as a recording medium; 2 denotes a disc motor for rotating and driving the optical disc 100; 2a denotes a turntable on which the optical disc is placed; 3 denotes a damper section provided on a rotation part of the disc motor 2 to support and chuck the optical disc 100 in a radial direction thereof; 4 denotes an optical pickup, 4a denotes an objective lens; 7 denotes a chassis as a first base which is an apparatus base; 8 denotes a bracket fixed to the chassis 7; 9 denotes a unit mechanism section formed with the disc motor 2 and optical pickup 4 mounted thereon; 91 denotes a unit mechanism deck member as a second base which is rotatable and displaceable relative to the chassis 7 within a plane substantially perpendicular to the plane of the chassis 7 and makes up a support portion of the unit mechanism section 9; 10 denotes a bottom case for covering the back surface side of the optical disc apparatus 1; 31 denotes an eject arm member; 31a denotes a disc abutting section of the eject arm member 31 abutting an outer peripheral surface of the optical disc 100 during the loading or unloading of the optical disc 100; 31c denotes a rotation support point of the eject arm member 31, 31b denotes an arm section of the eject arm member 31; 31e denotes an arm joint of the eject arm member 31; 30 denotes a raising and lowering mechanism for rotating the unit mechanism deck member 91 around the support point within the plane substantially perpendicular to the plane of the chassis 7 and vertically displacing it relative to the chassis 7; 60 denotes a feed motor rotating and driving a reed screw member (not shown) for moving the optical pickup 4 in a substantially radial direction of the optical disc 100; 80 denotes a loading motor generating a driving force for moving the optical disc 100 to be loaded or unloaded, 25 and 26 denote rotation support points of the unit mechanism deck member 91, where P-P′ is a line (hereinafter referred to as a support point line) passing through the rotation support points 25 and 26; 71 denotes a disc slot arm member for taking the optical disc 100 into an apparatus body; and 72 denotes a sub-lever member.

Further, reference numeral 5 denotes a cover member for covering plane areas located on both sides of an optical pickup move area 92 (a spatial area the optical pickup 4 occupies when moving in the substantially radial direction of the optical disc 100) of the unit mechanism section 9, of the plane areas on the unit mechanism deck member 91; 5a denotes a plane part of the cover member 5, covering the plane area on the side where the eject arm member 31 is provided, of the both plane areas; 5b denotes another plane part of the cover member 5, covering the plane area on the side where the feed motor 60 and the loading motor 80 are provided, of the both plane areas. The plane part 5a of the cover member 5, for example, makes it possible to prevent the optical pickup 4 from being raised due to bending of the flexible printed circuit (FPC) board for connection. The plane part 5b of the cover member 5, for example, makes it possible to prevent the lubricant from being pumped out of the reed screw member, the feed motor 60 and the like. In the optical disc apparatus 1, such a front surface side of the apparatus is covered with a top cover (not shown).

In the eject arm member 31, the rotation support point 31c is provided on the side of the chassis 7 or provided in engagement with the member on the side of the chassis 7. In the cover member 5, the plane part 5a has an end portion 5a₁ on the side of the disc insertion direction (the loading direction where the optical disc 100 is inserted and moved: Y-axis direction) restrained on the side of the chassis 7, namely, restrained by abutting the bracket 8 fixed to the chassis 7; and an end portion 5a₂ on the side of the disc ejection direction (the unloading direction where the optical disc 100 is ejected and moved: -Y-axis direction) fixed to the side of the unit mechanism deck member 91. The plane part 5b has an end portion 5b₁ on the side of the disc insertion direction and an end portion 5b₂ on the side of the disc ejection direction, which are both fixed to the side of the unit mechanism deck member 91. Because of this configuration, when the unit mechanism deck member 91 is rotated and displaced relative to the chassis 7, the plane part 5b of the cover member 5 is displaced along with the unit mechanism deck member 91 due to the rotation displacement, while the plane part 5a is maintained at a substantially constant height not depending on the rotation displacement. The plane part 5a is set at substantially the same height as the plane part of the bracket 8. During the loading or unloading of the optical disc 100, the plane part 5a abuts the rotating arm section 31b (corresponding to a portion extending from the arm joint 31e toward the end side, including the back surface side portion of the rotation support point 31c) of the eject arm member 31, to support the eject arm member 31 and restrict the height of the eject arm member 31 in the Z-axis direction. The plane part 5a abuts and supports the eject arm member 31 also in the initial state (FIG. 1) where the loading of the optical disc 100 is not performed, to restrain the height of the eject arm member 31 in the Z-axis direction.

In the above described configuration, for example, when the optical disc 100 is loaded, the optical disc 100 is inserted into the disc apparatus 1 in the Y-axis direction. The outer peripheral surface of the optical disc 100 abuts the disc abutting section 31a of the eject arm member 31 and pushes the disc abutting section 31a in the Y-axis direction, to rotate the eject arm member 31 around the rotation support point 31 in the direction of arrow E. In accordance with the rotation, the arm section 31b and the arm joint 31e are both rotated and displaced in the direction of arrow E. When the rotation displacement amount of the arm joint 31e reaches a predetermined value, the arm joint 31e presses a switch (not shown) to turn the power of the loading motor 80 on, and make the loading motor 80 being rotated. The rotary driving force of the loading motor 80 is transmitted to the disc slot arm member 71 and the sub-lever member 72 through a transmission gear array (not shown). These members are displaced, and then the optical disc 100 is automatically inserted into the apparatus body in the Y-axis direction. In the insertion operation, the outer peripheral surface of the optical disc 100 further pushes the disc abutting section 31a in the Y-axis direction, in abutting contact with the disc abutting section 31a of the eject arm member 31. Thus, the eject arm member 31 is further rotated and displaced around the rotation support point 31c. In the rotation displacement, after the start of the loading, namely, the start of the rotation displacement, the arm section 31b of the eject arm member 31 is supported by the plane part 5a in abutting contact with the plane part 5a of the cover member 5 in a first rotation range halfway through the loading. The arm section 31b is supported by the plane part of the bracket 8 fixed to the chassis 7 in a second rotation range including the loading completion position (the position where the play operation is available) following the first rotation range (FIG. 2). At the loading completion position (the position where the play operation is available), the disc abutting section 31a of the eject arm member 31 is to made to be separated from the outer peripheral surface of the optical disc 100 (FIG. 2). Also at the loading completion position (the position where the play operation is available), the whole eject arm member 31 including not only the disc abutting section 31a but also the rotation support point 31c, arm section 31b and arm joint 31c is made to be located outside the orthogonal projection area of the optical disc 100 (FIG. 2).

As described above, the rotary driving force of the loading motor 80 is also transmitted to the raising and lowering mechanism 30. Upon transmission of the rotary driving force of the loading motor 80, the raising and lowering mechanism 30 drives and pushes up a pin and the like (not shown) fixed to the side of the unit mechanism deck member 91, to move and displace the pin and the like in the Z-axis direction. Because the pin and the like is moved and displaced, the unit mechanism deck member 91 is rotated around the rotation support points 25 and 26, namely, around the support point line P-P′, so that the disc motor 2 and turntable 2a and damper section 3 on the unit mechanism deck member 91 are moved upward relative to the chassis 7. In accordance with the upward movement of the turntable 2a, the optical disc 100 is moved upward and is chucked while being pressed against an inner surface of the top cover (not shown). The chucking is performed at the timing when the disc abutting section 31a of the eject arm member 31 is separated from the outer peripheral surface of the optical disc 100. After the chucking, the raising and lowering mechanism 30 lowers the unit mechanism deck member 91 to a predetermined position. The loading of the optical disc 100 is completed at the predetermined position, and then the play operation is available in the optical disc 100. In the loading completion state (the state where the play operation is available), the surface of the unit mechanism deck member 91 is substantially parallel to the inner surface of the bottom case 10.

In the optical disc apparatus 1 according to the invention, the thickness dimension of the apparatus (the distance between the outer surface of the top cover and the outer surface of the bottom case 10) is assumed to be 9.5×10⁻³ m or less.

In the following description, the components in the apparatus configuration of FIGS. 1 and 2 are identified using the same reference numerals as in FIGS. 1 and 2.

FIG. 3 is an illustrative view of the eject arm member 31 and its support configuration in the optical apparatus 1 of FIGS. 1 and 2.

In FIG. 3, reference numeral 31d denotes a rotation center of the eject arm member 31; 31b₁ denotes a band-like convex portion protruded in the -Z-axis direction and formed inside the arm section 31b of the eject arm member 31 by press working or other methods; and 5a₁₁ denotes an engagement portion which is a part of the end portion 5a₁ on the side of the disc insertion direction of the plane part 5a of the cover member 5, abutting the bottom surface (the surface on the side of the -Z-axis direction) of the bracket 8 and being engaged therewith. The other reference numerals are the same as in FIGS. 1 and 2. The plane part 5a of the cover member 5 has the configuration of cantilever beam that an elastic restoring force acts in the Z-axis direction, where the engagement portion 5a₁₁ of the end portion 5a₁ is engaged with (latched to) the bottom surface of the bracket 8. Thereby, the plane part 5a is restrained by the bracket 8 with the elastic restoring force acting on the bottom surface of the bracket 8, and keeps the predetermined height position. During the loading of the optical disc 100, the convex portion 31b₁ of the arm section 31b of the eject arm member 31 in the first rotation range halfway through the loading abuts the plane part 5a of the cover member 5, for example, in the surface contacting state, and is supported by the plane part 5a. During the unloading of the optical disc 100, in the same manner as during the loading, the convex portion 31b₁ of the arm section 31b of the eject arm member 31 abuts the plane part 5a of the cover member 5 and is supported thereby.

FIG. 4 is a perspective view of the cover member 5 in the optical disc apparatus 1 of FIGS. 1 and 2.

In FIG. 4, reference numeral 5c denotes a slit between the plane parts 5a and 5b. The other reference numerals are the same as in FIGS. 1 to 3. The end portions 5a₂, 5b₁, 5b₂ are fixed to the side of the unit mechanism deck member 91 as the second base, and the end portion 5a₁ is restrained by the bracket 8. In other words, the plane part 5b between the end portions 5b₁ and 5b₂ performs a vertical movement operation along with the unit mechanism deck member 91, while the plane part 5a is hardly influenced by the vertical movement operation of the unit mechanism deck member 91 and keeps the predetermined height position. In the cover member 5 of FIG. 4, it is continuous between the end portions 5a₂ and 5b₂. However, the end portions 5a₂ and 5b₂ may be separated from each other.

FIG. 5 is a diagram showing an example of the displacement characteristic of the eject arm member 31 in the optical disc apparatus 1 of FIGS. 1 and 2.

In the characteristic of FIG. 5, the horizontal axis represents the insertion position (the Y-axis direction position) y of the optical disc 100 into the optical disc apparatus 1, the vertical axis represents the distance (hereinafter referred to as the separation distance) ξ that the eject arm member 31 is separated from the outer peripheral surface of the optical disc 100. In the horizontal axis, y₁ is the Y-axis direction position where the optical disc 100 begins to be inserted into the optical disc apparatus 1; y₂ is the Y-axis direction position where the outer peripheral surface of the optical disc 100 begins to contact (abut) the disc abutting section 31a of the eject arm member 31; y₃ is the Y-axis direction position where the support of the eject arm member 31 is changed from the support by the cover member 5 to that by the bracket 8; and y₄ is the Y-axis direction position where the insertion of the optical disc 100 is completed, namely, the loading is completed and the play operation is available. When the optical disc 100 is between the Y-axis direction positions y₁ and y₃, the eject arm member 31 abuts the plane part 5a of the cover member 5 and is supported thereby. When the optical disc 100 is between the Y-axis direction positions y₃ and y₄, the eject arm member 31 abuts the plane part of the bracket 8 and is supported thereby. The range between the Y-axis direction positions y₂ and y₃ corresponds to the first rotation range of the eject arm member 31. The range between the Y-axis direction positions y₃ and y₄ corresponds to the second rotation range of the eject arm member 31.

Further, in the characteristic of FIG. 5, the zero “0” point for the separation distance ξ in the vertical axis is the position where the eject arm member 31 directly abuts the outer peripheral surface of the optical disc 100 or comes into contact with the orthogonal projection area of the optical disc 100. The negative range of the separation distance ξ is the area where a part of the eject arm member 31 is beyond the outer peripheral surface of the optical disc 100 and overlaps the disc surface, namely, the range where a part of the eject arm member 31 penetrates the orthogonal projection area of the optical disc 100.

Further in the characteristic of FIG. 5, a is the characteristic curve indicating the distance that the end portion in the vicinity of the disc abutting section 31a of the eject arm member 31 is separated from the outer peripheral surface of the optical disc 100; b is the characteristic curve indicating the distance that an intermediate portion in a rotation radial direction of the arm section 31b of the eject arm member 31 is separated from the outer peripheral surface of the optical disc 100; and c is the characteristic curve indicating the distance that the intermediate portion in the rotation radial direction of the arm section of the eject arm member in the conventional technology (such as, for example, the eject lever descried in JP-A-2002-352498) is separated from the outer peripheral surface of the optical disc 100. In the optical disc apparatus 1 of FIGS. 1 and 2, as indicated by the characteristic curves a and b, the eject arm member 31 is configured so that neither the intermediate portion of the arm section 31b in the rotation radial direction nor the end portion in the vicinity of the disc abutting section 31a penetrates the orthogonal projection area of the optical disc 100 (if the end portion penetrates, but the penetration amount is small), in the range between the Y-axis direction positions y₂ and y₄. At least at the Y-axis direction position y₄, every part of the eject arm member 31 is made to be located outside the orthogonal projection area of the optical disc 100. On the other hand, in the case of the eject arm member in the conventional technology, as indicated by the characteristic curve c, the intermediate portion in the rotation radial direction of the arm section of the eject arm member penetrates the orthogonal projection area of the optical disc 100 in the range between the Y-axis direction positions y₂ and y₄, remaining within the orthogonal projection area also at the Y-axis direction position y₄. The same is nearly true for the end portion in the vicinity of the disc abutting section.

In the optical disc apparatus 1 of FIGS. 1 and 2, the eject arm member 31 has the displacement characteristic as indicated by the characteristic curves a, b, where, in particular, the eject arm member 31 can be located outside the orthogonal projection area of the optical disc 100 at the Y-axis direction position y₄. This is mainly based on the fact that the arm section 31b of the eject arm member 31 has a curved shape with a reduced width dimension. In the optical disc apparatus 1 of FIGS. 1 and 2, the rotated and displaced eject arm member 31 is supported by the plane part 5a of the cover member 5 and by the plane of the bracket 8, so that the eject arm member 31 can be stably supported. As a result, it is possible to make the eject arm member 31 curved and narrower. Thus, in the optical disc apparatus 1 of FIGS. 1 and 2 as the embodiment of the present invention, the curve-shaped and narrow-width eject arm member 31 is stably supported by the plane part 5a of the cover member 5 and by the plane of the bracket 8, in order to reduce the thickness of the apparatus.

FIGS. 6A, 6B, 7A and 7B are illustrative views of the thickness reduction effect in the optical disc apparatus 1 of FIGS. 1 and 2. FIGS. 6A and 6B are cross-sectional views of the support configuration for the case where the narrow-width eject arm member 31 is supported by the plane part 5a of the cover member 5 and by the plane of the bracket 8 in the optical disc apparatus 1 of FIGS. 1 and 2. FIGS. 7A and 7B are cross-sectional view of the support configuration for the case where the wide-width eject arm member is supported by the guide shaft as in the conventional technology.

FIG. 6A is the case where the optical disc 100 is in the initial state before loading, namely, at a position between the Y-axis direction positions y₁ and y₂ in FIG. 5. FIG. 6B is the case where the optical disc 100 is at a playable position after completion of the loading, namely, at the Y-axis direction position y₄ in FIG. 5. In the state of FIG. 6A, the outer peripheral surface of the optical disc 100 comes into contact with the disc abutting section 31a of the eject arm member 31 at the position y₂, and pushes the eject arm member 31 in the direction of arrow E (FIGS. 1 and 3). At this time, the arm section 31b of the eject arm member 31 abuts the plane part 5a of the cover member 5 and is supported by the plane part 5a. Here, ho is the height dimension from the inner surface of the bottom case 10 to the plane part 5a of the cover member 5; h₁ is the height dimension from the inner surface of the bottom case 10 to the bottom surface of the optical disc 100; g₁ is the gap dimension between the surface of the arm section 31b of the eject arm member 31 and the bottom surface of the optical disc 100; t is the thickness dimension of the arm section 31b of the eject arm member 31; and H is the distance between the outer surface of the top cover 11 and the outer surface of the bottom case 10, namely, the thickness dimension of the optical disc apparatus. In the state of FIG. 6B, the eject arm member 31 is supported in such a way that the disc abutting section 31a is separated from the outer peripheral surface of the optical disc 100, every part including the arm section 31b is located outside the orthogonal projection area of the optical disc 100, and the arm section 31b abuts the plane part of the bracket 8. Here, h₂ is the height dimension from the inner surface of the bottom case 10 to the bottom surface of the optical disc 100 having been chucked by the damper section 3 and placed on the turntable 2a; and g₂ is the gap dimension between the bottom surface of the optical disc 100 and the surface of the arm section 31b of the eject arm member 31. As described above, in the optical disc apparatus 1 shown in FIGS. 1 and 2, the height position of the back surface (the surface abutting the plane part 5a of the cover member 5) of the arm section 31b of the eject arm member 31 is substantially as low as the height dimension h₀ in both FIGS. 6A and 6B. The gap dimensions g₁, g₂ are reduced as well. Thus, the height position of the optical disc 100 is incidentally lowered. As a result, it is possible to make the apparatus thinner in the optical disc apparatus 1. Incidentally, the unit mechanism deck member 91 is inclined relative to the inner surface of the bottom case 10 in the state of FIG. 6B, and is substantially parallel to the inner surface of the bottom case 10 in the state of FIG. 6B.

Similarly, FIG. 7A is the case where the optical disc 100 is in the initial state before loading, namely, at a position between the Y-axis direction positions y₁ and y₃ in FIG. 5. FIG. 7B is the case where the optical disc 100 is at a playable position after completion of the loading, namely, at the Y-axis direction position y₄ in FIG. 5. In FIGS. 7A and 7B, reference numeral 5′ denotes a cover member for covering plane areas on the unit mechanism deck member; 5a′ denotes a plane part of the cover member 5′; 8′ denotes a bracket; 10′ denotes a wide-width eject arm member; 31a′ denotes a disc abutting section of the eject arm member 31′ abutting the outer peripheral surface of the optical disc 100; 31b′ denotes a wide-width arm section of the eject arm member 31′; 31c′ denotes a rotation support point of the eject arm member 31′; 31d′ denotes a rotation center of the eject arm member 31′; and 201′ denotes a guide shaft for supporting the bottom surface of the eject arm member 31′ during the loading or unloading of the optical disc 100.

In the state of FIG. 7A, the wide-width arm section 31b′ of the eject arm member 31′ abuts the end of the guide shaft 201′ and is supported by the end thereof. Here, h₀′ is the height dimension from the inner surface of the bottom case 10′ to the plane part 5a′ of the cover member 5′; h₁′ is the height dimension from the inner surface of the bottom case 10′ to the bottom surface of the optical disc 100; g₁′ is the gap dimension between the surface of the arm section 31h′ of the eject arm member 31′ and the bottom surface of the optical disc 100; j₁′ is the gap dimension between the plane part 5a′ of the cover member 5′ and the bottom surface of the eject arm member 31′; and t′ is the thickness dimension of the arm section 31b′ of the eject arm member 31′. The gap dimension j₁′ is formed in such a way that the height of the guide shaft 201′ is set higher than the height of the plane part 5a′ of the cover member 5′.

In the state of FIG. 7B, a part of the wide-width arm section 31b′ of the eject arm member 31′ abuts the plane part of the bracket 8′ and is supported by the plane thereof. The plane part of the bracket 8′ is provided at substantially the same height as the end of the guide shaft 201′. Here, Δh₀′ is the distance that the plane part 5a′ of the cover member 5′ is raised from the height position h₀′ along with the unit mechanism deck member; h₂′ is the height dimension from the inner surface of the bottom case 10′ to the bottom surface of the optical disc 100 having been chucked and placed on the turntable; g₂′ is the gap dimension between the bottom surface of the optical disc 100 and the surface of the arm section 31b′ of the eject arm member 31′; j₂′ is the gap dimension between the plane part 5a′ of the cover member 5′ and the bottom surface of the eject arm member 31′.

In FIGS. 7A and 7B, the heights of the back surface (the surface abutting the end of the guide shaft 201′ or the plane part of the bracket 8′) of the arm section 31b′ of the eject arm member 31′, h₀′+j₁′ and h₀′+Δh₀′+j₂′, are higher than the height h₀ of the back surface of the arm section 31b of the eject arm member 31 in FIGS. 6A and 6B. For example, in the case of h₀′=h₀, the height positions of the back surface of the arm section 31b′ of the eject arm member 31′ in FIGS. 7A and 7B are higher by j₁′, Δh₉′+j₂′ respectively than the height position of the back surface of the arm section 31b of the eject arm member 31 in FIGS. 6A and 6B. Further, in the case of FIG. 7B, where a part of the wide-width eject arm member 31′ is within the orthogonal projection area of the optical disc 100, the optical disc 100 is provided at a height position sufficiently separated from the surface of the eject arm member 31′, in order to prevent the disc surface from coming into contact therewith. In other words, when the optical disc 100 is rotated for recording or reproduction, the gap dimension g₂′ is set to a larger value taking into account the displacement of the disc surface or other factors, in order to prevent the disc surface from coming into contact with the eject arm member 31′, even if the disc surface is displaced in the Z-axis direction due to decentering and the like. Thus, the height h₂′ of the bottom surface of the optical disc 100 in FIG. 7B has a larger value than the height h₂ of the bottom surface of the optical disc 100 in FIG. 6B. For example, assuming that g₂′=t+g₂, in the case of FIG. 6B, the height of the bottom surface of the optical disc 100 is h₂=h₀+t+g₂=h₀+g₂′, while in the case of FIG. 7B, the height of the bottom surface of the optical disc 100 is h₂′=h₀′+Δh₀′+j₂′+t′+g₂′. Also assuming that h₀′=h₀, the height is h₂′=h₀+Δh₀′+j₂′+t′+g₂′=h₂+Δh₀′+j₂′+t′.

As described above, in the case of the optical disc apparatus 1 of FIGS. 1 and 2 (FIGS. 6A and 6B), the height positions of the eject arm member 31 and the optical disc can be substantially lowered compared to the case of the conventional technology (FIGS. 7A and 7B). As a result, in the optical disc apparatus 1 of FIGS. 1 and 2, it is possible to make the apparatus thinner with the thickness dimension of the apparatus, namely, the distance between the outer surface of the top cover 11 and the outer surface of the bottom case 10, equal to or less than 9.5×−10³ m. Further, as the configuration is such that the eject arm member 31 is supported using the cover member 5, the height restriction member such as the guide shaft member is not necessary. This also contributes to reduction of the number of parts and the reduction of costs.

As described above, according to the embodiment of the present invention, the narrow-width eject arm member can be stably supported, so that it is possible to make the apparatus thinner by lowering the height position of the disc surface, in the state where the disc surface is protected during the loading and unloading of the optical disc 100.

Although the case of the optical disc apparatus of slot-in type has been described in the above embodiment, the present invention is not limited thereto and is applicable to an optical disc apparatus of other method and configuration.

The present invention may be applied to other embodiments without departing from the sprit or essential characteristic thereof. Thus, the above described embodiment is merely an example of the present invention throughout the description, and it should not be understood from a limiting point of view. The scope of the present invention is defined by the appended claims. Further, various changes and modifications belonging to the equivalent scope of the claims are all within the scope of the present invention.

What is claimed is:

1. An optical disc apparatus comprising a configuration for rotating and displacing an eject arm member to load and unload an optical disc relative to an apparatus body, said optical disc apparatus comprising:
a first base as an apparatus base;
a second base displaceable relative to the first base within a plane substantially perpendicular to a plane of the first base, and making up a support portion of a unit mechanism section including an optical pickup;
an eject arm member rotated and displaced around the rotation support point within a plane substantially parallel to the plane of the first base, in abutting contact with an outer peripheral surface of the optical disc, during the loading and unloading of the optical disc, and
a cover member covering plane areas located on both sides of an optical pickup move area of the unit mechanism section, of the plane areas on the second base,
the cover member including a plane part for covering the plane area on the eject arm side, of the both plane areas,
the plane part having an end portion on the side of the disc insertion direction restrained on the first base side, and during the loading and unloading of the optical disc, abutting the eject arm member in the restrained state to support the eject arm member.

2. The optical disc apparatus according to claim 1, wherein
the eject arm member is configured to be located outside an orthogonal projection area of the optical disc upon completion of the loading of the optical disc.

3. The optical disc apparatus according to claim 1, wherein the cover member is configured so that the plane part covering the plane area on the side of the eject arm member of the both plane areas, has the end portion on the side of the disc insertion direction, abutting the bracket fixed to the first base side and is restrained thereby.

4. The optical disc apparatus according to claim 1, wherein the cover member is configured so that the plane part covering the plane area on the side of the eject arm member of the both plane areas, has the end portion on the side of the disc insertion direction, abutting the bracket fixed to the first base and is restrained thereby, and that a plane part covering the plane area on the other side of the both plane areas is fixed to the second base.

5. The optical disc apparatus according to claim 1, wherein the arm member is configured to be supported by abutting the plane part of the cover member in a first rotation range halfway through the loading after the start of loading of the optical disc, and supported by the plane part of the bracket fixed to the first base in the second rotation range including the loading completion position.

6. The optical disc apparatus according to claim 5, wherein the cover member and the bracket are configured so that the heights of the respective plane parts are substantially equal to each other.

7. The optical disc apparatus according to claim 1, wherein the cover member is configured so that an end portion on the side of the disc ejection direction of the plane part is fixed to the second base.

8. The optical disc apparatus according to claim 1, wherein the second base is configured to be rotated and displaced around a support point provided on the first base side.

9. The optical disc apparatus according to claim 1, wherein the thickness dimension of the apparatus is configured to be 9.5×10⁻³m or less.

10. The optical disc apparatus according to claim 2, wherein the thickness dimension of the apparatus is configured to be 9.5×10⁻³ m or less.

11. The optical disc apparatus according to claim 3, wherein the thickness dimension of the apparatus is configured to be 9.5×10⁻³ m or less.

12. The optical disc apparatus according to claim 4, wherein the thickness dimension of the apparatus is configured to be 9.5×10⁻³m or less.

13. The optical disc apparatus according to claim 5, wherein the thickness dimension of the apparatus is configured to be 9.5×10⁻³ m or less.

14. The optical disc apparatus according to claim 6, wherein the thickness dimension of the apparatus is configured to be 9.5×10⁻³ m or less.

15. The optical disc apparatus according to claim 7, wherein the thickness dimension of the apparatus is configured to be 9.5×10⁻³ m or less.

16. The optical disc apparatus according to claim 8, wherein the thickness dimension of the apparatus is configured to be 9.5×10⁻³ m or less.
